(19) United States
(12) Patent Application Publication
(10) Pub. No.: US 2005/0144152 A1
(43) Pub. Date: Jun. 30, 2005

(54) Symbol-based query mechanism

(76) Inventors: Murali Punaganti, Vantaa (FI); Chand Malu, Vantaa (FI); Petteri Saarinen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/516,281

(22) PCT Filed: May 28, 2003
(86) PCT No.: PCT/FI03/00422

(51) Int. Cl. G06F 7/00

(52) U.S. Cl. 707/1

(57) ABSTRACT

A technique for processing a query request from a terminal (TE) to a search engine (SE). A terminal user is allowed to select querry parameters by means of visual symbols, ie icons, such as a “here” symbol (94) and a “bank” symbol (95). Symbol identifiers (91, 93) of the user-selected symbols, and optional logical operators (92) are sent (10-2) from the terminal to a proxy server (PS) that replaces (10 4, 10-8) each symbol identifier in the query request with a plaintext description and presents (10-10) the query parameters in a query to the search engine (SE). If the proxy server (PS) detects a “here” symbol (94), it may query a location server (LS) to get the terminal's location which it then converts to plaintext. The query results are conveyed (10-16) to the terminal (EE).

### BACKGROUND OF THE INVENTION

The invention relates to methods and equipment for initiating and processing queries, such as database searches. Such queries are frequently used to retrieve various types of information and services, such as banks, hotels, restaurants, entertainment, and the like. For Internet users, the best-known search engine, www.google.com, has proved invaluable..

A primary problem associated with the prior art query mechanisms is that they are cumbersome to use with mobile terminals that do not have a full-size alphanumeric keyboard. While some mobile terminals do have an alphanumeric keyboard, physical constraints limit the size of the keyboard, and typing keywords for search is awkward. A secondary problem is that current search engines provide poor support for tourists in a country whose language they do not speak.

### BRIEF DESCRIPTION OF THE INVENTION

An object of the present invention is to provide methods and equipment for solving the primary problem that relates to the limited keyboards of current mobile terminals. The object of the invention is achieved by the methods and equipment which are characterized by what is stated in the independent claims. The preferred embodiments of the invention, that are disclosed in the dependent claims, provide additional advantages.

The invention is based on the idea of symbols to simplify keyword entry. Each symbol comprises at least a symbol identifier and visual data. The visual data of at least a subset of the symbols are displayed to a terminal user via the terminal's user interface. The user selects one or more symbols. The symbol identifiers of the user-selected symbols are collected until the user is satisfied with the set of symbols. Then the symbol identifiers of the user-selected symbols are sent to a proxy server that recognizes the symbol identifiers. The proxy server converts the symbol identifiers to corresponding plaintext descriptions and formats a query according to the syntax of a suitable search engine, such as the above-mentioned www.google.com. The proxy server receives the query results from the search engine and conveys the results to the terminal.

Typically, each symbol corresponds to one word or similar semantic entity. This is not an absolute requirement, however. By virtue of the symbol identifiers, the symbols are not tied to a specific human language, and some words in one language translate to multiple words in another. But we can say that each of a large majority of the symbols corresponds to one word.

It should also be noted that while the user uses graphic symbols (visual data) to select query parameters, the visual data need not be sent to the proxy server but only the symbol identifiers. This is because the proxy server does not search for an arbitrary graphic image but recognizes well-defined and system-wide symbol identifiers. The final query generated by the proxy server is entirely text-based, because conventional web search engines use text-based queries.

The visual data is intended for an iconic representation of a symbol. This means that the bitmap size (in a bitmap) or level of detail (in a vector format) should be so small that resource consumption is minimized, but not so small that symbols cannot be recognized reliably, given the size and resolution of typical displays.

An aspect of the invention is a method for operating a terminal. Another aspect of the invention is a suitably programmed terminal. Yet other aspects of the invention relate to methods and equipment of the proxy server. A yet further aspect of the invention is a symbol server for downloading further symbols to a terminal.

An advantage of the invention is that conventional search engines operating on the Internet can be conveniently accessed from a terminal that does not have a full-size keyboard. The search engines themselves need not be modified to support the use of symbols. Another advantage of the invention is that multi-language support can be implemented with relative ease. Visual representations of symbols and the symbol identifiers are language-independent, and relatively little added effort is needed to store the plaintext descriptions in multiple languages on the network side, whereby visiting network users can be supported in their own language. A query from the terminal may then comprise a “desired language” indicator, in which case the proxy server replaces each symbol identifier in the query request with a plaintext description in a language that matches the “desired language” indicator. Additionally, there may be a “desired language” indicator for the results of the query, in which case the proxy server can use an internal or external translation engine to translate the results of the query. Preferably, there is a default value for the desired language(s), so that the terminal user need not select the language for each query.

### BRIEF DESCRIPTION OF THE DRAWINGS

In the following the invention will be described in greater detail by means of preferred embodiments with reference to the attached drawings, in which

FIG. 1 is a schematic illustration of a symbol;

FIG. 2 illustrates a symbol in a mark-up language;

FIG. 3 illustrates an optional symbol hierarchy;

FIG. 4 illustrates a user interface for selecting symbols;

FIG. 5 shows a network arrangement in which the invention can be used;

FIG. 6 shows a flowchart for specifying query parameters on the basis of symbols;

FIG. 7 shows query parameters and logical operators for an exemplary query;

FIG. 8 shows a signalling diagram for processing a simple query;

FIG. 9 shows a query that contains a “here” symbol;

FIG. 10 shows a signalling diagram for processing a query that contains a “here” symbol;

FIG. 11 shows a signalling diagram for processing a query in case a list of possible terminal locations is known;

FIG. 12 shows an exemplary query request in a mark-up language; and

FIG. 13 shows a signalling diagram for downloading symbols in a network arrangement as shown in FIG. 5.

### DETAILED DESCRIPTION OF THE INVENTION

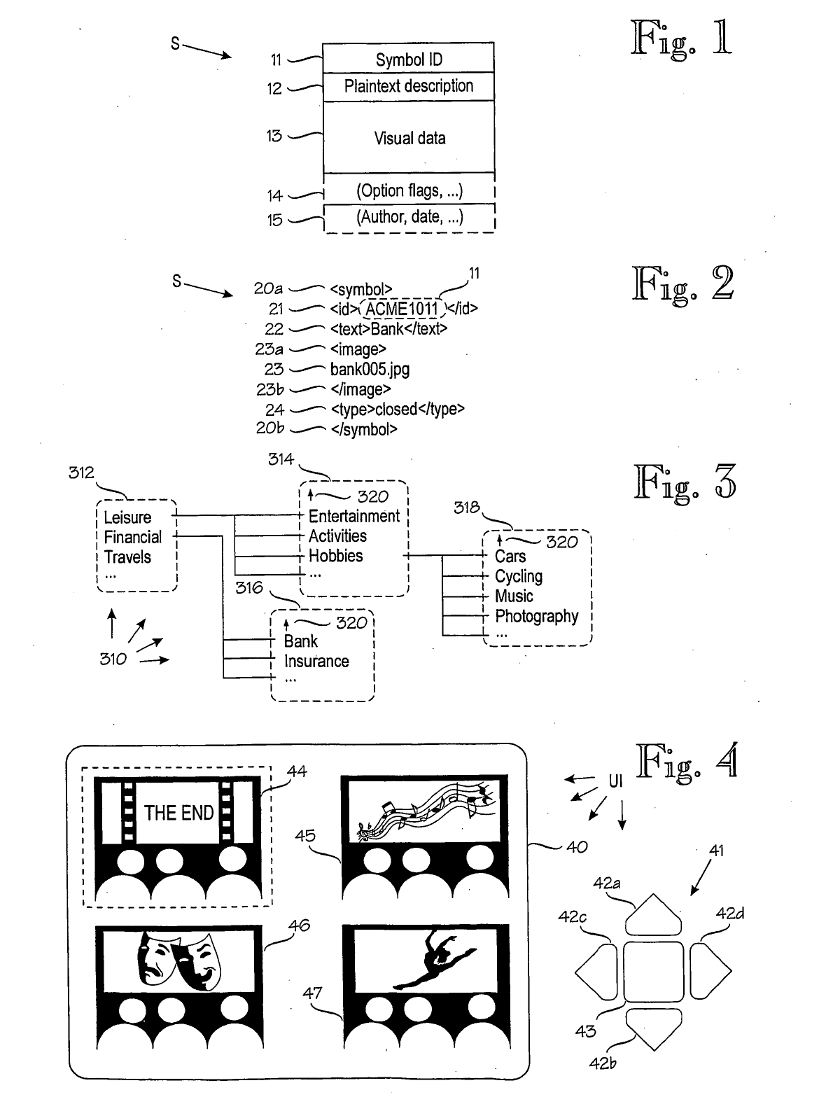

In the attached figures, the first digit of a reference numeral indicates the figure in which the corresponding item is first described. For instance, item 11 is first described in FIG. 1.

FIG. 1 is a schematic illustration of a symbol, generally denoted by reference sign S. The essential components of the symbols S are symbol identifier 11 and visual data 13. The symbol identifier 11 will be used to create query parameters for the query. The visual data 13 is used to visually present the symbols in a user interface. The visual data 13 can be incorporated in the symbol S itself, or it can be a reference, such as an filename (and an optional directory path) to a separate image file. For example, the visual data 13 may be in a scalable vector graphics (SVG) format, or it may be a bitmap. An advantage of the scalable vector graphics format is that the symbol is better viewable in devices having different resolutions.

The visual data is not a piece of art per se and is only intended for an iconic representation of a symbol. Thus the level of detail should be dimensioned such that symbols can be reliably distinguished but resource consumption is minimized. Given a display resolution of a few hundred or a thousand pixels in each direction, the visual data should not exceed 100 pixels in either direction, and 32 by 32 pixels, or the equivalent amount of detail in a vector representation, can be considered a reasonable size. Note that a large number of different symbols requires a detailed iconic representation in order to make the symbols distinguishable.

Preferably, the symbol S also comprises a plaintext description 12. The plaintext description can be selectively shown to remind a user as to what the symbol means. Also, the plaintext description can be used to obtain more symbols from external sources, as will be described later.

The symbol S may also comprise an optional field 14 for indicating certain optional settings, commonly called flags. For example, there may be a flag that indicates whether the symbol can be modified by the user. If there is an option for preventing users from modifying symbols, the symbol must also comprise some integrity checking, such as checksums or hash codes, as is well known to persons skilled in cryptography. Further, the programs for checking the integrity must be executed in protected memory.

The symbol S may also comprise an optional field 15 for indicating authorship, source, creation date, version, etc. It is envisioned that telecommunication network operators will be able to charge small amounts of money for symbols downloaded from their networks, and such authorship indicators will be useful. As regards this invention, however, the field 15 is not essential.

FIG. 2 illustrates a symbol S in a mark-up language, such as XML (extendible mark-up language). The symbol shown in FIG. 2 is self-explanatory to a person with some knowledge in XML. Rows 20a and 20b delineate the symbol. Row 21 comprises the symbol identifier 11. Row 22 comprises the plaintext description. Rows 23a and 23b delineate the visual data 23 which in this example is a filename of “bank005.jpg”. Alternatively, the visual data 23 may be comprised as inline code within the symbol S. A benefit of the embodiment shown in FIG. 2, in which the visual data 23 is a reference to an external image file, is that the symbols S are very small and can be stored in multiple places of a symbol hierarchy without consuming too much memory. Alternatively, the visual data 23 can be defined as an attachment to the symbol S, particularly in a case in which the symbol is coded in XML.

FIG. 3 illustrates an optional symbol hierarchy. According to a preferred embodiment of the invention, the symbols S are ordered in a symbol hierarchy, generally denoted by reference numeral 310. The hierarchy resembles a file directory and is self-explanatory to any person with some knowledge in computers, and the hierarchy is preferably user-modifiable.

The hierarchy 310 has a root 312, two first-level branches 314, 316 and one second-level branch 318. Each branch in the hierarchy 310 comprises an up symbol 320 for navigating to a higher-level branch. Or, the user interface may comprise a key dedicated for that purpose.

FIG. 4 illustrates a user interface for selecting symbols. A terminal's user interface UI comprises a display 40 and a set of cursor control keys, commonly denoted by reference numeral 41. In this example, the cursor control keys comprise four direction keys 42a to 42d, and a selector key 43.

Assume that the terminal user has navigated to branch 314 shown in FIG. 3. This branch comprises symbols for entertainment. The display 40 shows symbols 44 to 47 for movies, concerts, theatres and ballet, respectively. More symbols can be seen by pressing the direction keys 42a to 42d. One of the symbols 44 to 47 is referred to as “the symbol under the cursor” and is shown by a dashed outline. In this example, it is the symbol 44 for movies. When the user presses the selector key 43, the symbol under the cursor is selected and its symbol identifier is accepted as a query parameter.

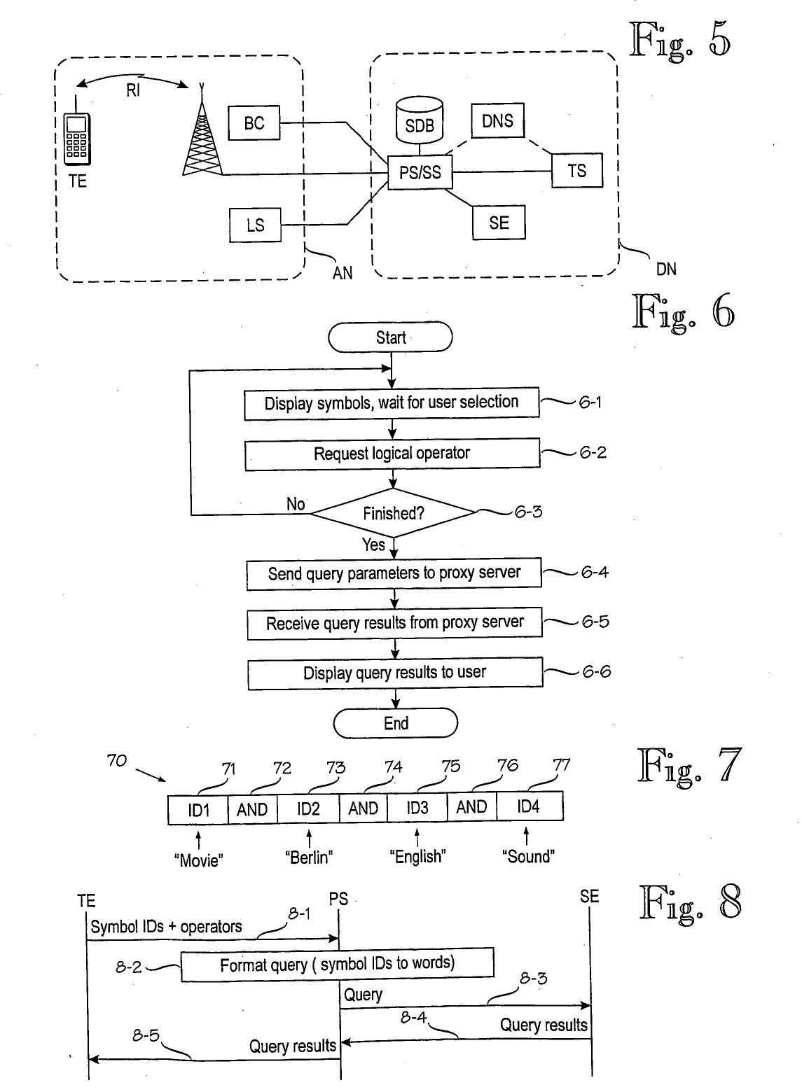

FIG. 5 shows a network arrangement in which the invention can be used. A key element of the invention is the component labelled PS/SS which stands for proxy server and symbol server. The proxy server PS and symbol server SS serve two separate functions, but they are preferably integrated in a single network element. The proxy/symbol server PS/SS is connected to a data network DN, such as the Internet or a public switched telephone network (PSTN). The proxy/symbol server PS/SS comprises or is connected to a symbol data base SDB for storing a large collection of symbols. Reference sign SE denotes a search engine, such as the Google.

In the embodiment shown in FIG. 5, a user terminal TE, such as a mobile telephone, accesses the proxy/symbol server PS/SS via a radio interface RI and an access network AN. For example, the access network may be a cellular network. Most of the network elements of the access network AN are omitted. However, a mobile location server LS and a billing centre are shown, and they relate to various preferred embodiments of the invention.

The symbol data base SDB contains the plaintext description 12 for the symbols S. As a result, the proxy server PS can convert incoming symbol identifiers to corresponding plaintext descriptions and pass them on the search engine SE.

According to another preferred embodiment of the invention, the symbol data base SDB contains the plaintext description 12 for the symbols S in several human languages. An advantage achieved by storing the plaintext descriptions in several human languages is that a symbol server SS in one country may serve visiting users in their own languages. The symbol server SS may determine the user's language on the basis of an explicit indication in the symbol request. Alternatively, the symbol server SS may be operated by the operator of the access network AN or the internet service provider ISP, in which case the symbol server SS may determine the user's language on the basis of an inquiry to a subscriber register. As a further alternative, the symbol server SS may be operated on a subscription basis such that the user needs to register with the service, in which case the symbol server knows the user's language on the basis of the registration.

According to another preferred embodiment of the invention, the symbol server SS is part of a network-wide or global hierarchy of symbol servers. FIG. 5 shows an optional top-level server TS. If the symbol server SS does not have a requested symbol, it may contact the another server, such as the top-level server TS. The symbol server SS may obtain network addresses of other servers via a domain name server DNS.

According to yet another preferred embodiment of the invention, the symbol server SS is adapted to send a billing centre BC of the access network AN a billing data record that indicates the number, price and/or type of symbols transferred to the terminal. Thus the network operator may charge the terminal subscriber for the transferred symbols.

FIG. 6 shows a flowchart for specifying query parameters on the basis of symbols. The user is prompted for symbols such that the set of symbols indicate the query parameters. In step 6-1 the user is allowed to navigate and select among the symbols. From the user interface point of view, this step can be implemented as shown in FIGS. 3 and 4. In an optional step 6-2 the user is prompted for a logical operator, such as AND or OR. Alternatively, the user may select a logical operator similarly to selecting symbols. The symbol identifiers 11 of the symbols indicated by the user and the optionally requested logical operators are added to the query. Step 6-1 and the optional step 6-2 are repeated until the user indicates that the set of symbols for the query is complete in step 6-3. For example, a user who wishes to eat fish in a quiet restaurant may enter a query like “restaurant AND fish NOT music”. In step 64 the terminal sends the query parameters to the proxy server. In steps 6-5 and 6-6 the terminal receives the query results from the proxy server and displays them to the user.

FIG. 7 shows query parameters and logical operators for an exemplary query. Assume that the user wishes to locate movies in Berlin that have an English-language soundtrack. The user uses the procedure shown in FIG. 6 to enter four symbol identifiers ID1 to ID4 that will be used as query parameters. In this example the first symbol identifier 71 is the symbol identifier for “Movie”. The second symbol identifier 73 is the symbol identifier for “Berlin”. The two last symbol identifiers 75 and 77 mean “English” and “Sound”, respectively. In this example, odd numerals 71 to 77 denote query parameters (symbol identifiers for search keys), while the even numerals 72 to 76 denote the connecting logical operators or the corresponding symbols. In FIG. 7, all logical operators are “AND”, as indicated by the ampersands. As is well known, AND is the default operator for Google, and the terminal may either use AND as default operator, or omit it entirely if the user does not enter an operator. Other search engines may use a different syntax, and a technique for indicating a preferred search engine will be disclosed in connection with FIG. 12. Depending on the implementation chosen, the logical operators 72, 74, 76 may be sent as the actual operators (AND, OR, NOT) or as corresponding symbol or operator identifiers. In many cultures, the English-language operators (AND, OR, NOT) are used as such. Accordingly, a proxy server should be able to recognize these operators. Naturally, it is also possible to assign an operator identifier to each of these operators.

FIG. 8 shows a signalling diagram for processing a simple query. The query parameters have been collected in the terminal as shown in connection with FIGS. 6 and 7. In step 8-1 the terminal TE sends the query parameters (the symbol identifiers 71, 73, 75 and 77, and optionally, the logical operators, 72, 74 and 76) to the proxy server PS. In step 8-2 the proxy server PS formats a query according to the syntax of the search engine SE, such as the Google. The query formatting comprises converting the symbol identifiers 71, 73, 75 and 77 to the corresponding plaintext descriptions which the proxy server PS retrieves from the (internal or external) symbol data base SDB. In step 8-3 the proxy server PS sends the formatted query to the search engine SE. In step 84 the proxy server PS receives the query results which it conveys to the terminal TE in step 8-5.

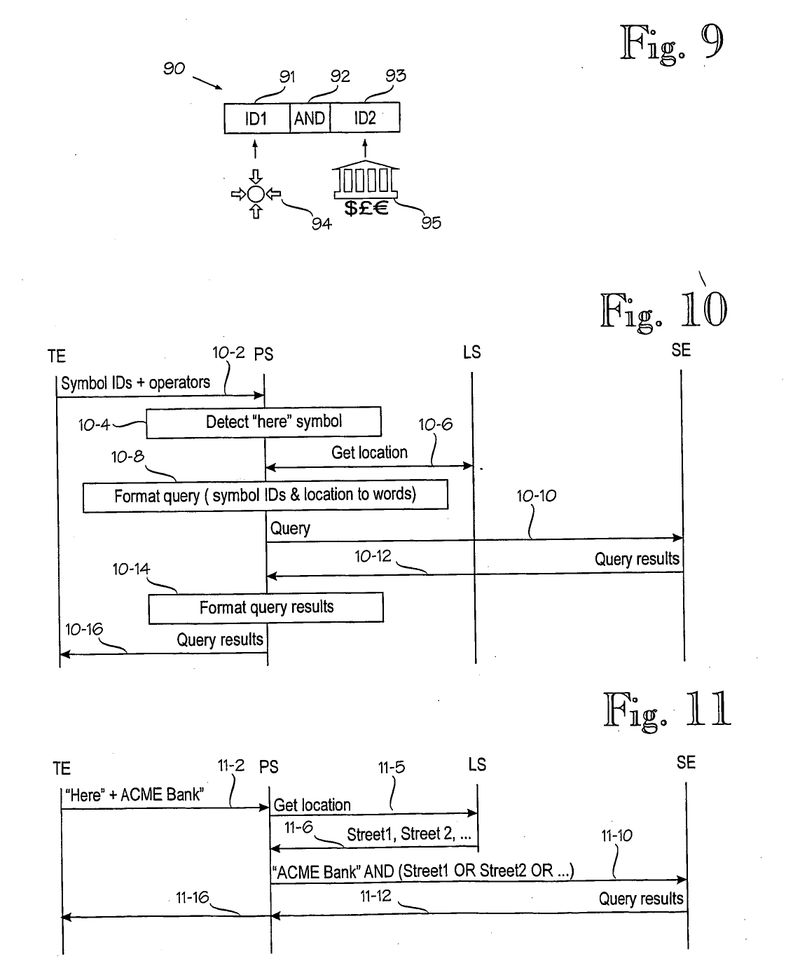

FIGS. 9 to 11 relate to queries in which the terminal's location plays a key role. FIG. 9 shows a query that contains a “here” symbol. Many queries relate to the terminal's location but the terminal user may not know the location. Or, the terminal user may not be able to express the location in a syntax that is meaningful to the proxy server PS and/or the search engine SE. Accordingly, it is advantageous to use a “here” symbol.

Assume that the user wishes to search for nearby banks. Accordingly, the user enters a “here” symbol and a bank symbol, denoted by reference numerals 94 and 95, respectively. The set 90 of query parameters comprises a symbol identifier 91 for the “here” symbol 94 and symbol identifier 93 for the bank symbol 95, and a connecting AND operator 92. As discussed in connection with FIG. 7, the AND operator can be transmitted as such or as a corresponding symbol.

FIG. 10 shows a signalling diagram for processing a query that contains a “here” symbol. The set of query parameters (symbol identifiers and operators) is collected as shown in FIG. 9. In step 10-2 the terminal TE sends the set of query parameters to the proxy server PS. In step 104 the proxy server PS detects the “here” symbol identifier 91 contained in the set of query parameters. According to another preferred embodiment of the invention, in response to detecting the “here” symbol identifier, the proxy server PS queries the location server LS for the terminal's location. (For some applications, requesting a user's location may require that user's permission, but in this example the proxy server is only providing services for the user, and a permission is implied.) In step 10-6 the proxy server requests and obtains the terminal's location from the location server LS. In step 10-8 the proxy server formats a query on the basis of the set of query parameters in which the “here” symbol identifier is converted to a plaintext description of the terminal's location.

The reason for converting the “here” symbol identifier to a plaintext description of the terminal's location (instead of precise coordinates) is as follows. It is technically possible for the proxy server PS to maintain a data base of services, such as banks, doctors, entertainment, etc. based on geographical coordinates, but maintaining an up-to-date list of services based on geographical coordinates is very labour-intensive. For example, entertainment schedules are updated daily or weekly, and it is far better to use existing Internet-based search engines and services. This can be accomplished if the terminal's location is converted to a plaintext description. The proxy server may contain a conversion table (not shown separately) for converting the location server's output to a plaintext description. For example, if the location server LS returns coordinates which indicate that the terminal is in Kensington, London, then the coordinates will be converted to a plaintext description of “Kensington”. Alternatively the coordinates-to-plaintext conversion table may be located in the location server LS. In this example, the formatted query is simply “bank kensington”. This query is sent to the search engine in step 10-10. In step 10-12 the search engine returns the query results. In an optional step 10-14 the proxy server PS may format the query results. For example, the query results can be translated to the terminal user's preferred language with a translation engine. Alternatively, the query results may be formatted to the small displays in most portable terminals. In step 10-16 the query results are conveyed to the terminal TE.

FIG. 11 shows a signalling diagram for processing a query in case a list of possible terminal locations is known. In step 11-2 the terminal sends query parameters “here” and “ACME Bank”. This means that the user wishes to locate local offices of ACME Bank. In step 11-5 the proxy server PS requests the terminal's location from the location server LS. In this embodiment, the coordinates-to-plaintext conversion table is located in the location server LS, and the location server returns a list of possible streets in which the terminal TE may be located. As is well known, some mobile positioning techniques are based on the terminal's current cell identity, and a cell of a cellular network may encompass several streets. According to the embodiment shown in FIG. 11, the proxy server PS formats the query as follows. The elements in the list of locations (the possible street names) are separated by an OR operator, and the list is combined to the remaining query parameters with an AND operator. In this example, the user's query parameters “here” and “ACME Bank” are converted to “ACME Bank AND (Street1 OR Street2 OR . . . )”.

Assume now that the terminal user is visiting a foreign country, and the user does not speak the language of that country. To support visiting users, it is preferable to store the plaintext descriptions in multiple languages on the network side, whereby visiting network users can be supported in their own language. A query from the terminal may then comprise a “desired language” indicator (not shown separately) for the query results. For example, an English-speaking user may search for local banks in a Spanish-speaking country. In this case, the proxy server PS converts the symbol identifier for “bank” to a plaintext description of “banco” and passes it to the search engine SE. If the user's desired language for the query results is English, the proxy server may then translate the query results to English, for example, by using a web-based translation service or an internal translation engine.

According to yet another preferred embodiment of the invention, there may be a “desired language” indicator for the actual query (not the results) in which case the proxy server replaces each symbol identifier in the query request with a plaintext description in a language that matches the “desired language” indicator. To use the previous example of an English-speaking user in a Spanish-speaking country, the user may indicate that the actual query is performed in English. For example, the user may not be interested in local banks but in banking business in general, in which case the query should be processed in the user's own language.

FIG. 12 shows an exemplary query request 120 in a mark-up language. Rows 121a and 121b delineate the query request. Rows 122a and 122b delineate the header of the query request. In this example, the header contains row 123 that indicates the terminal's identity, which is shown as an MSISDN (Mobile Subscriber Integrated Services Data Network) identity. The proxy server PS will send the terminal identity as a parameter to the location server LS, so that the location server knows the terminal whose location is requested. Rows 124a and 124b delineate the body of the query request. Row 125 contains the actual query parameters, that is, the symbol identifiers and the optional logical operators. For example, sym-id1 may be the symbol identifier for “vegetarian” and sym-id2 may be the symbol identifier for “restaurant”.

Rows 126 to 128 are optional enhancements. Row 126 specifies the terminal user's preferred search engine to which the query is to be passed. The proxy server should be able to convert the logical operators to the syntax of the preferred search engine, but this is not a difficult task, considering the fact that there are only a few logical operators and well-known search engines.

Rows 127 and 128 are examples of desired language indicators. Row 127 specifies that the actual query is to be performed in Spanish. For example, if the terminal users wishes to find vegetarian restaurants in a Spanish-speaking area, the query should be performed in Spanish. Row 128 specifies the result or output language to which the result of the query is to be translated (by using an internal or external translation engine).

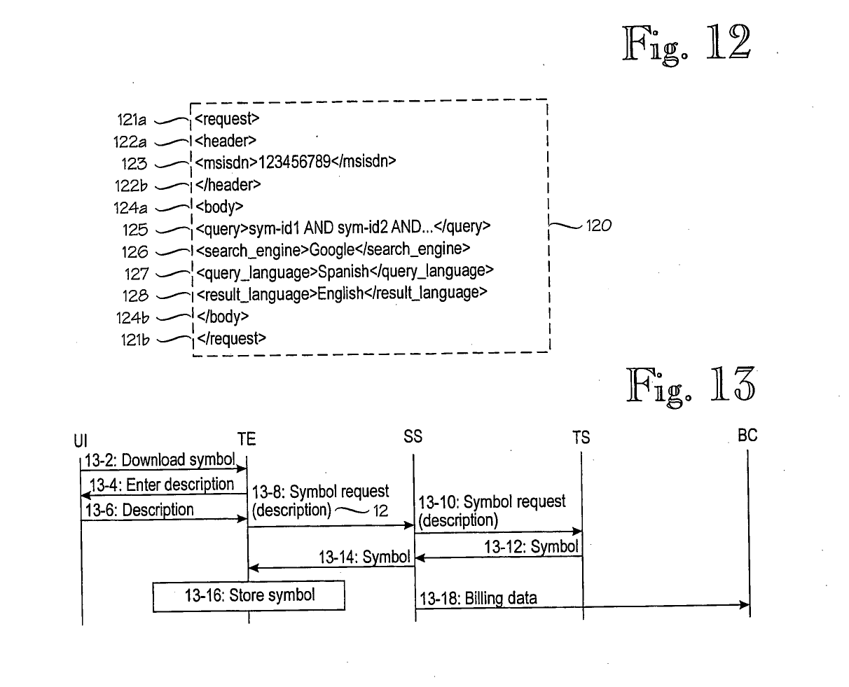

FIG. 13 shows a signalling diagram for downloading symbols in a network arrangement as shown in FIG. 5. It is virtually impossible to make a terminal TE that contains all the symbols that users will ever need. Accordingly, situations will arise in which it is desirable to obtain more symbols. FIG. 13 shows a technique for downloading symbols from a symbol server SS.

In step 13-2 the user enters, via the user interface UI, a request to download a specific symbol. In step 134 the terminal TE prompts the user for a description for the symbol. The description corresponds to items 13 and 22 in FIGS. 1 and 2. In step 13-6 the user enters the description. In step 13-8 the terminal TE sends the symbol server SS a request for a symbol corresponding to the user-entered description. If the symbol server SS (or the associated symbol data base SDB) has the requested symbol, it will send the symbol to the terminal. In this example, however, we will assume that the symbol server does not have the requested symbol. The symbol server SS is preferably part of a network-wide or global hierarchy of symbol servers in which a symbol server consults another server, such as a top-level server, if it does not have a requested symbol. In this case the local symbol server SS conveys the symbol request to the top-level server TS, which is assumed to have the requested symbol. Or, the top-level server TS may send an inquiry for other symbol servers (this step not shown separately). In step 13-12 the top-level server sends the requested symbol to the local symbol server SS which conveys it to the terminal TE in step 13-14. In step 13-16 the terminal TE stores the downloaded symbol in its memory. In an optional step 13-18 the symbol server SS sends the billing centre BC billing data, such as a charging data record, that indicates the number, price and/or type of symbols transferred to the terminal.

For clarity, FIG. 13 shows a scenario in which a single symbol is downloaded in response to a single request. That is, the symbol request 13-8 only indicates a single symbol. As an alternative, the symbol request 13-8 can indicate several symbols, in which case all the requested symbols (or that are all available to the symbol server) are downloaded together. As a yet further alternative, a single symbol request 13-8 may indicate a logical group of symbols that are downloaded together. For instance, a theme group of symbols, such as “entertainment”, can be downloaded as a group, whereby a symbol does not have to be requested and downloaded for each type of entertainment separately. Similarly, at the time of major events, such as the Olympic games or the football World cup, network operators may offer related symbols as groups. Especially with such symbol groups, it is advantageous to download the symbols in compressed form so as not to waste telecommunication resources.

If the symbol hierarchy 310 shown in FIG. 3 is used, the downloaded symbols may indicate a default branch in the hierarchy, whereby the user does not have to navigate to that location explicitly. For example, a symbol for “Operas” may have a row of “<domain>Entertainment</domain>”.

FIG. 13 shows an embodiment in which the terminal prompts the user for a description of a symbol to be downloaded. It is equally possible to use a shopping-cart analogy, in which the user browses the symbol server and selects one or more symbols for downloading. The two approaches (prompting and browsing) can be mixed such that if the symbols server (or the higher-level server) does not have a requested symbol, the user is allowed to browse the available symbols. The shopping cart analogy is not perfect, however, because browsing a large collection of symbols visually requires that the visual data of symbols must be transferred to the user's terminal, which may consume large amounts of radio resources. Accordingly, the user may be offered a chance to browse the plaintext descriptions of the symbols. Or, the user may browse the available symbols with a personal computer and create a set of symbols to be downloaded. The set of symbols can then be downloaded directly to the terminal. Or, the set of symbols can be first downloaded to the computer, from which the symbols are transferred to the terminal via any suitable interface, such as a Bluetooth interface, serial connection, infrared link, or the like. Moreover, detachable memory cards may be transferred between the user terminal TE and the personal computer PC.

If several symbols are to be downloaded at a time, it is beneficial if the downloading takes place at a time when transmission charges are low, which typically means night-time. On the other hand, it may be inconvenient for the terminal user to request symbol downloading at night. Accordingly, it is beneficial if the symbol downloading can be specified to take place at some predetermined point in the future. The point in the future in the future may mean a specific hour, such as after midnight. Alternatively, it may mean any point of time when a specific set of criteria are satisfied. For instance, it is envisioned that future telecommunication networks may use dynamic tariffs, based on current load. The networks broadcast advertising messages that announce the current tariff or special discount. Thus one example of a criterion is that the tariff is below a given threshold. Another example of a criterion is that there is a radio connection to a specified network. For instance, some multi-purpose mobile terminals can be used off-line on airplanes, and the user may specify in advance that a set of symbols relevant to the visited country will be downloaded as soon as a radio connection can be established.

Thus it is beneficial if the terminal can defer sending the download request until a predetermined point of time or until a set of conditions are met. Alternatively, the terminal may specify the set of conditions in the symbol request to the symbol server, in which case the symbol server defers transmission until the set of conditions are met.

In connection with FIG. 1, it was stated that the visual data of symbols should be detailed enough to permit reliable recognition of symbols, but not so detailed as to consume large amounts of resources. Accordingly, the symbol server may store the visual data of symbols in multiple resolutions (or in a resolution-independent vector form), and the visual data of symbols transferred to the terminal is dimensioned according to the size and resolution of the terminal's display.

According to yet another preferred embodiment of the invention, the symbol server is adapted to update existing symbols in the terminal and/or the proxy server. For instance, such updating may comprise transferring the plaintext description of symbols in one or more new languages.

While various embodiments of the invention have been described in detail, it should be understood that many modifications to the embodiments can be made without departing from the scope of the invention. For example, the attached drawings show the search engine SE and the proxy server PS as separate elements, but it is equally possible to implement the proxy server as an internal front-end to the search engine. Similarly, the two inventive elements, namely the proxy server PS and the symbol server SS have been shown as integrated in a single network element, but it is equally possible to separate these elements. Also, the terminal TE is shown as a wireless terminal that does not have a full-size keyboard. It is not essential that the terminal is wireless or lacks a full-size keyboard, however, and some benefits of the invention are achieved with conventional desktop computers. The word ‘terminal’ implies that the device can act as a terminal, in other words, send query parameters and receive query results. Yet further, the billing aspects of the invention have been shown only in connection with symbol downloading, but it is equally possible to charge the terminal subscriber for acting as a convenient front-end to conventional search engines. Moreover, the inventive servers and databases can be installed in the access network, instead of being installed in the data network, as shown in the attached drawings.

1-42. (canceled)

43. A method for initiating a query from a terminal, the method comprising:
storing in the terminal a plurality of symbols, wherein each symbol comprises at least a symbol identifier and visual data;
forming, in the terminal, a set of user-selected symbols, the forming step comprising:
(a) presenting the visual data of one or more symbols to a user;
(b) in response to the user selecting a symbol, adding the symbol to the set of user-selected symbols;
(c) repeating at least step until termination by the user;
the terminal sending a proxy server a set of query parameters, such that the set of query parameters indicates the set of user-selected symbols and at least one of the query parameters is a symbol identifier; and
receiving the results of the query.

44. A method for processing a query request from a terminal, the method comprising the following steps executed by a proxy server:
storing a plurality of symbols, wherein each symbol comprises at least a symbol identifier and a plaintext description;
receiving the query request from the terminal, the query request comprising a set of query parameters, such that the set of query parameters indicates a set of user-selected symbols and at least one of the query parameters is a symbol identifier;
replacing each symbol identifier in the query request with a corresponding plaintext description and presenting the query parameters in a query to the search engine; and
conveying the results of the query to the terminal.

45. A method according to claim 44, further comprising, in response to detecting a “here” symbol as one of the query parameters, determining the terminal's approximate location and converting the approximate location to a plaintext form.

46. A method according to claim 45, further comprising consulting a mobile location server.

47. A method according to claim 45, further comprising, if the terminal's approximate location in plaintext form is a list of locations, separating the elements of the list of locations with an “OR” operator in the query.

48. A method according to claim 44, further comprising:
storing the plaintext description of at least some symbols in multiple languages;
detecting a “desired language” indicator in the query request; and
replacing each symbol identifier in the query request with a plaintext description in a language that matches the “desired language” indicator.

49. A method according to claim 44, wherein the step of receiving the query request from the terminal is preceded by the steps of:
a symbol server receiving one or more symbol requests from the terminal; and
the symbol server transferring the terminal one or more symbols that match the one or more symbol requests.

50. A method according to claim 49, wherein the one or more symbol requests comprise a plaintext description.

51. A method according to claim 44, further comprising consulting another server if the query request comprises a symbol identifier for which a corresponding symbol is not stored in the proxy server.

52. A method according to claim 50, further comprising consulting another server if the symbol request comprises a plaintext description for which a corresponding symbol is not stored in the symbol server.

53. A method according to claim 49, wherein the transferring step comprises transferring a logical group of symbols.

54. A method according to any one of claim 49, wherein the transferring step takes place when a set of user-specified criteria are met.

55. A method according to claim 54, wherein the transferring step comprises transferring a logical group of symbols in response to a single user act or request.

56. A terminal for initiating a query, the terminal comprising:
memory for storing a plurality of symbols, wherein each symbol comprises at least a symbol identifier and visual data;
a user interface logic for forming a set of user-selected symbols, wherein the user interface logic comprises:
(a) a first routine for presenting the visual data of symbols to a user for selection by the user;
(b) a second routine for adding each user-selected symbol to the set of user-selected symbols, until termination by the user;
a logic for sending a set of query parameters to a proxy server, such that the set of query parameters indicates the set of user-selected symbols and at least one of the query parameters is a symbol identifier.

57. A terminal according to claim 56, further comprising means for requesting and receiving symbols from an external device.

58. A terminal according to claim 56, wherein each symbol also comprises a flag indicating whether the symbol is user-modifiable.

59. A terminal according to claim 56, further comprising a symbol hierarchy, the symbol hierarchy having a root and multiple branches.

60. A terminal according to claim 56, wherein the terminal is operable to store at least one symbol in multiple branches.

61. A terminal according to claim 56, wherein the symbol is coded in a mark-up language.

62. A terminal according to claim 56, wherein the visual data is in a scalable vector graphics format.

63. A terminal according to claim 56, wherein the visual data is a reference to an image file separate from the symbol.

64. A terminal according to claim 57, further comprising means for requesting said symbols at a user-specified time.

65. A terminal according to claim 57, further comprising means for requesting said symbols when a set of user-specified criteria are met.

66. A proxy server for processing a query request from a terminal, the proxy server comprising:
a database for storing a plurality of symbols, wherein each symbol comprises at least a symbol identifier and a plaintext description;
a first logic for receiving the query request from the terminal, the query request comprising a set of query parameters, such that the set of query parameters indicates a set of user-selected symbols and at least one of the query parameters is a symbol identifier;
a second logic for replacing each symbol identifier in the query request with a plaintext description;
a third logic for presenting the query parameters in a query to a search engine; and
a fourth logic for conveying results of the query to the terminal.

67. A proxy server according to claim 66, further comprising:
a fifth logic for detecting a “here” symbol in the query request and for converting the “here” symbol to the terminal's approximate location.

68. A proxy server according to claim 67, wherein the fifth logic comprises means for consulting a mobile location server.

69. A proxy server according to claim 67, wherein the fifth logic comprises means for receiving the terminal's approximate location as a list of elements, and means for presenting the elements of the list to the search engine, separated by an OR operator between any two elements.

70. A proxy server according to claim 66, wherein the database stores the plaintext description in several human languages for at least some of the symbols.

71. A proxy server according to claim 70, further comprising:
means for detecting a “desired language” indicator for the query; and
means for selecting a plaintext description for each symbol in a language indicated by the “desired language” indicator.

72. A proxy server according to claim 70, further comprising:
means for detecting a “desired language” indicator for the results of the query; and
means for translating the results of the query to a language indicated by the “desired language” indicator.

73. A proxy server according to claim 66, further comprising:
means for detecting a preferred search engine indicator for the results of the query; and
means for presenting the query parameters to the search engine indicated by the preferred search engine indicator.

74. A proxy server according to claim 66, further comprising means for sending a billing centre an indication on the number, price and/or type of query requests received from the terminal.

75. A symbol server for sending one or more symbols to a terminal, the symbol server comprising:
a symbol data base for storing a plurality of symbols, wherein each symbol comprises at least a symbol identifier, and visual data;
means for receiving a symbol request from the terminal; and
means for sending one or more symbols that match the symbol request to the terminal.

76. A symbol server according to claim 75, wherein each symbol also comprises at least one plaintext description.

77. A symbol server according to claim 75, wherein the symbol request comprises a plaintext description of the symbol indicated by the symbol request and the symbol server is operable to send the terminal one or more symbols that comprise the plaintext description comprised in the symbol request.

78. A symbol server according to claim 76, wherein at least some symbols comprise the plaintext description in several human languages.

79. A symbol server according to claim 78, further comprising means to detect a desired language indicator in the symbol request; and means for sending the one or more symbols with a plaintext description in a language that matches the desired language indicator.

80. A symbol server according to claim 75, further comprising means for consulting another server if the symbol server does not contain a symbol matching the symbol request.

81. A symbol server according to claim 75, further comprising means for sending a billing centre an indication on the number, price and/or type of symbols transferred to the terminal.

82. A symbol server according to claim 75, further comprising means for sending the one or more symbols at a time indicated by the symbol request.

83. A symbol server according to claim 75, further comprising means for sending the one or more symbols when a set of criteria indicated by the symbol request are met.

84. A symbol server according to claim 75, further comprising means for updating existing symbols in the terminal and/or a proxy server.
